(19) United States
(12) Patent Application Publication
(10) Pub. No.: US 2019/0224594 A1
(43) Pub. Date: Jul. 25, 2019

(54) PORTABLE FILTERING APPARATUS AND SYSTEM

(71) Applicant: David Douglas Dieziger, Bonners Ferry, ID (US)

(72) Inventor: David Douglas Dieziger, Bonners Ferry, ID (US)

(21) Appl. No.: 16/254,298

(22) Filed: Jan. 22, 2019

Related U.S. Application Data
(60) Provisional application No. 62/620,226, filed on Jan. 22, 2018.

(51) Int. Cl. B01D 29/56; B01D 29/00; B01D 29/07; B01D 35/30

(52) U.S. Cl. CPC B01D 29/56; B01D 29/0022; B01D 29/0004; B01D 2201/12; B01D 35/301; B01D 2221/08; B01D 29/07

(57) ABSTRACT

An apparatus includes a separator tank and a filter tank. The separator tank includes an inlet configured to receive liquid, an outlet, and a vertical baffle dividing the separator tank into an inlet section and an outlet section. The filter tank is in fluid communication with the outlet and includes a distribution tray approximately at a top of the filter tank and a horizontal baffle below the distribution tray. The horizontal baffle is spaced vertically from the distribution tray forming a first capacity reservoir. The horizontal baffle is further spaced vertically above a bottom of the filter tank to form a second capacity reservoir.

### CROSS-REFERENCES TO RELATED APPLICATIONS

This application claims the benefit of U.S. Provisional Patent Application No. 62/620,226 entitled “PORTABLE FILTERING APPARATUS AND SYSTEM” and filed on Jan. 22, 2018 for David Dieziger, which is incorporated herein by reference.

### FIELD

This invention relates to methods, apparatuses, and systems for filtering and more particularly relates to portable methods, apparatuses, and systems for filtering.

### BACKGROUND

Filtered water is important for many applications. Removing undesirable contaminants such as chemicals or biological contaminants can be difficult and costly. Such difficulties can be compounded in remote locations where fixed infrastructure cannot be built or implemented and/or in locations where only a temporary need exists.

### SUMMARY

An apparatus is disclosed. The apparatus is an apparatus for filtering liquid. The apparatus includes a separator tank and a filter tank. The separator tank includes an inlet configured to receive liquid, an outlet, and a vertical baffle dividing the separator tank into an inlet section and an outlet section. The filter tank is in fluid communication with the outlet and includes a distribution tray approximately at a top of the filter tank and a horizontal baffle below the distribution tray. The horizontal baffle is spaced vertically from the distribution tray forming a first capacity reservoir. The horizontal baffle is further spaced vertically above a bottom of the filter tank to form a second capacity reservoir. Other embodiments are also disclosed.

In some embodiments, the horizontal baffle comprises a filter configured to filter particles smaller than one hundred micron.

In some embodiments, the first capacity reservoir is configured to store a volume of water between the distribution tray and the horizontal baffle while the water filters through the horizontal baffle. In some embodiments, the horizontal baffle is pleated.

In some embodiments, the filter tank is separate from the separator tank.

In some embodiments, the separator tank and the filter tank are configured to be coupled to a portable trailer.

In some embodiments, the vertical baffle comprises an opening approximately at a bottom of the vertical baffle, the opening fluidly connecting the inlet section and the outlet section.

In some embodiments, the separator tank further comprises an absorbent pad in the inlet section. In some embodiments, the absorbent pad floats within the inlet section and is configured to float above the inlet

In some embodiments, the inlet is positioned below a top of the separator tank.

In some embodiments, the separator tank further includes a drain positioned at a bottom of the separator tank and a liner above the drain and spanning the bottom the separator tank. In some embodiments, the liner comprises a filter configured to filter particles larger than one hundred microns.

In some embodiments, the distribution tray comprises a plurality of apertures arrayed in a grid on the distribution tray and configured to distribute water across the horizontal baffle.

In some embodiments, the filter tank further comprises a filter tank outlet positioned at a bottom of the filter tank configured to release filtered water from the second capacity reservoir.

In some embodiments, the outlet is positioned at a top of the separator tank and is configured to dispense liquid above the distribution tray of filter tank.

A system is disclosed. The system includes a portable trailer and an apparatus coupled to the portable trailer. The apparatus includes a separator tank and a filter tank. The separator tank includes an inlet configured to receive liquid, an outlet, and a vertical baffle dividing the separator tank into an inlet section and an outlet section. The filter tank is in fluid communication with the outlet and includes a distribution tray approximately at a top of the filter tank and a horizontal baffle below the distribution tray. The horizontal baffle is spaced vertically from the distribution tray forming a first capacity reservoir. The horizontal baffle is further spaced vertically above a bottom of the filter tank to form a second capacity reservoir. Other embodiments are also disclosed.

In some embodiments, the first capacity reservoir is configured to store a volume of water between the distribution tray and the horizontal baffle while the water filters through the horizontal baffle.

In some embodiments, the separator tank is coupled to the portable trailer by a hinged edge configured to tip the separator tank at the hinged edge.

In some embodiments, the separator tank further includes a drain positioned at a bottom of the separator tank and a liner above the drain and spanning the bottom the separator tank, wherein the liner comprises filter configured to filter particles larger than one hundred microns.

A multi-stage filter apparatus is disclosed. The multi-stage filter apparatus includes a separator tank comprising an inlet configured to receive liquid, an outlet, and a vertical baffle dividing the separator tank into an inlet section and an outlet section, wherein the vertical baffle comprises an opening approximately at a bottom of the vertical baffle, the opening fluidly connecting the inlet section and the outlet section, wherein the separator tank further comprises an absorbent pad in the inlet section, wherein the absorbent pad floats within the inlet section, and wherein the separator tank further comprises a drain positioned at a bottom of the separator tank and a liner above the drain and spanning the bottom the separator tank, wherein the liner comprises a wire mesh. The multi-stage filter apparatus further includes a filter tank in fluid communication with the outlet, wherein the filter tank comprises a distribution tray approximately at a top of the filter tank, and a substantially horizontal baffle below the distribution tray, wherein the horizontal baffle is spaced vertically from the distribution tray forming a first capacity reservoir and is further spaced vertically above a bottom of the filter tank to form a second capacity reservoir, and wherein the horizontal baffle comprises a filter configured to filter particles smaller than one hundred micron. Other embodiments are also disclosed. Methods of filtering water are also disclosed.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view illustrating one embodiment of an apparatus in accordance with some embodiments of the present invention;

FIG. 2 is a top view illustrating one embodiment of an apparatus in accordance with some embodiments of the present invention;

FIG. 3 is a side view illustrating one embodiment of a system in accordance with some embodiments of the present invention;

FIG. 4 is a top view illustrating another embodiment of an apparatus in accordance with some embodiments of the present invention;

FIG. 5 is a side view illustrating one embodiment of a system in accordance with some embodiments of the present invention;

FIG. 6 is a schematic block diagram illustrating a system in accordance with some embodiments of the present invention; and

FIG. 7 is a schematic block diagram illustrating a method in accordance with some embodiments of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Various methods have been used to filter water. Some methods are prohibitively expensive in remote locations. In some cases the need for filtering is temporary as well. For these and other reasons, improved portable filtering systems are needed.

Embodiments of the invention allow for portable filtering systems. Some embodiments allow for on demand reservoirs of filtered water. Some embodiments allow for improved mobility of filtering systems.

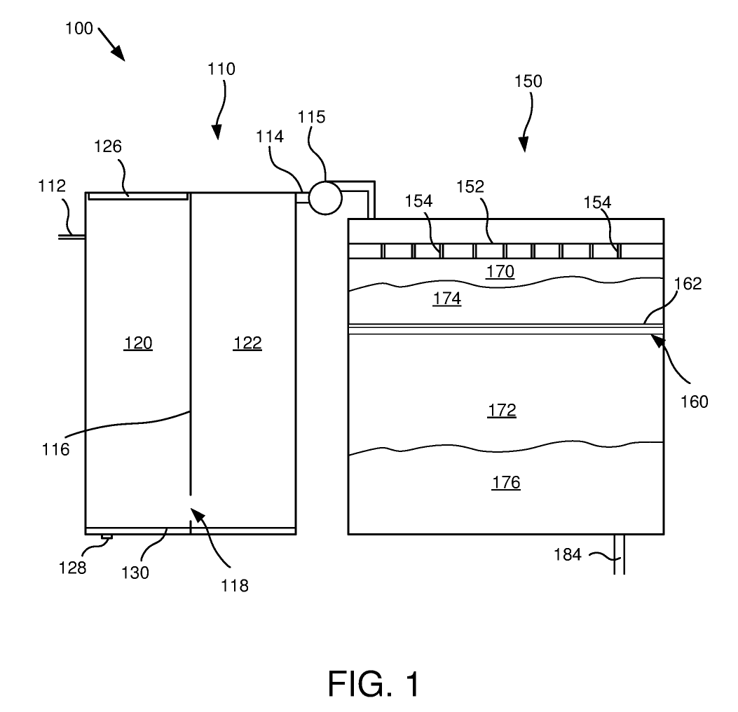

FIG. 1 depicts a side plan view of an apparatus 100 in accordance with one embodiment of the present invention. Although the apparatus 100 is shown and described with certain components and functionality, other embodiments of the apparatus 100 may include fewer or more components to implement less or more functionality.

The apparatus includes a separator tank 110 and a filter tank 150. The separator tank 110 is a container including an inlet 112, an outlet 114 and a vertical baffle 116. In some embodiments, the inlet 112 is configured to receive a liquid. Although described as liquid generally, the liquid may be unfiltered water or another fluid contaminated with particulates or other solid particles or liquid waste that may be miscible or immiscible.

The inlet 112, in some embodiments, is configured to receive the liquid from a fluid source. The inlet 112 may include multiple connections to allow for the inlet 112 to fluidly connect to a variety of fluid sources. As some embodiments of the apparatus are configured to be portable, such embodiments are configured to attach different fluid sources.

The inlet 112, in some embodiments, is configured to pass the liquid into an interior of the separator tank 110. The separator tank 110 includes a vertical baffle 116 in the interior of the separator tank 110. Although depicted as a vertical and linear baffle in FIG. 1, some embodiments of the vertical baffle 116 may include other geometric configurations to separate or divide the interior of the separator tank 110 into sections. In some embodiments, the vertical baffle 116 is configured to divide the separator tank 110 into an inlet section 120 and an outlet section 122. As shown in FIG. 1, the inlet section is proximal the inlet 112.

In some embodiments, the inlet 112 is located near the top of the separator tank 110 but spaced below the top surface of the separator tank 110. In the illustrated embodiment the inlet 112 is located approximately one foot below the top of the separator tank 110. In such embodiments, the location of the inlet 112 allows for an absorbent pad 126 to be located above the inlet within the inlet section 120.

In some embodiments, the absorbent pad 126 is configured to absorb contaminants or other undesired fluids within the water. In some embodiments, the absorbent pad 126 is configured to absorb oil or other contaminants that are less dense than the water. The less dense fluids will float towards the top of the inlet section 120 and be absorbed by the absorbent pad 126. Some embodiments may include a plurality of absorbent pads 126 within the inlet section 120.

In some embodiments, the absorbent pad 126 is configured to float within the inlet section 120. As the inlet section 120 is filled with the liquid, the absorbent pad 126 will float above the inlet 112. In other embodiments, the absorbent pad 126 may be removably coupled or fixedly coupled to the top of the inlet section 120 or at a location above the inlet 112.

In some embodiments, the inlet section 120 and the outlet section 122 are fluidly connected. In the illustrated embodiment, the inlet section 120 and the outlet section 122 are fluidly connected through an opening 118 located on the vertical baffle 116. Although described as an opening on the vertical baffle 116, the opening 118 may merely be a gap between the vertical baffle 116 and the separator tank 110.

In some embodiments, the opening 118 is approximately at a bottom of the vertical baffle 116. Approximately may refer to below twenty five percent of the height of the separator tank 110. As an example, for a separator tank 110 six feet tall, the opening 118 would be below one and a half feet from the bottom of the separator tank 110. In some embodiments, the opening 118 is located at a point below five percent of the height of the separator tank 110.

As depicted in FIG. 1, the liquid enters at the inlet 112 and flows downwards in the inlet section 120, through the opening 118 at a bottom of the vertical baffle 116 and into the outlet section 122. In the outlet section 122, the liquid flows upwards toward an outlet 114. The fluid flow of the liquid in this manner allows for larger particles and contaminants to fall and settle at the bottom of the separator tank 110 as the liquid flows upwards towards the outlet 114.

In some embodiments, the separator tank 110 further includes a drain 128 positioned at a bottom of the separator tank 110. The drain 128 is configured, in some embodiments, to facilitate draining of the separator tank 110 after use of the apparatus 100.

Some embodiments may further include a liner 130 which covers or separates the drain 128 from the remainder of the interior of the separator tank 110. In some embodiments, the liner 130 may span the bottom of the separator tank 110. In some embodiments, the liner 130 may span a portion of the bottom of the separator tank 110. In some embodiments, the liner 130 may line the bottom and the sides of the interior of the separator tank 110. In some embodiments, the liner 130 may span only the bottom of the inlet section 120. In some embodiments, the liner 130 may span only the bottom of the outlet section 120 in cases where the drain 128 is located in the outlet section 122. In some embodiments, the liner 130 is located proximal to the drain 128 and lines only a portion of the bottom of the separator tank 110.

In some embodiments, the liner 130 includes a filter. The filter may be configured to filter larger particles. In some embodiments, the filter may be configured to filter particles larger than one hundred microns. In some embodiments, the filter may be configured to filter smaller or larger particles or other contaminants. Such embodiments may allow for the separator tank 110 to be drained on location at the filtering site or near location of the filtering site without further dumping the contaminants that settled on the bottom of the separator tank 110.

In some embodiments, the liner 130 may includes a porous wire mesh. The porous wire mesh may allow the sludge or fluid accumulation in the separator tank 110 to be drained while trapping sand or other larger particles. In some embodiments, the liner 130 is located below the opening 118. In some embodiments, the liner 130 is located above the opening 118. In some embodiments, the liquid may flow through the liner 130 prior to flowing through the opening 118 or after flowing through the opening 118. In some embodiments, the liner 130 includes two or more materials. In one embodiment, the liner 130 includes a coarse filter and a fine filter. In another embodiment, the liner 130 includes a metal mesh and a fine filter. In another embodiment, the liner 130 includes a metal mesh and a ceramic filter.

The apparatus 100 further includes an outlet 114. In some embodiments, the outlet 114 is positioned at a top of the separator tank. In some embodiments, the outlet 114 is positioned at a top of the outlet section 122. Such embodiments ensure that the liquid travels down to the bottom of the separator tank 110, through the opening 118 and up to the top of the separator tank 110. Such embodiments allow for the settling of contaminants in the bottom of the separator tank 110 during the fluid flow.

In some embodiments, the outlet 114 is configured to dispense liquid to the filter tank 150. In some embodiments, the outlet 114 is configured to dispense the liquid at a location above the filter tank 150. In some embodiments, the outlet 114 is coupled to the filter tank 150. In some embodiments, the outlet 114 is not coupled to the filter tank 150 but is configured to dispense the liquid at a location above the filter tank 150.

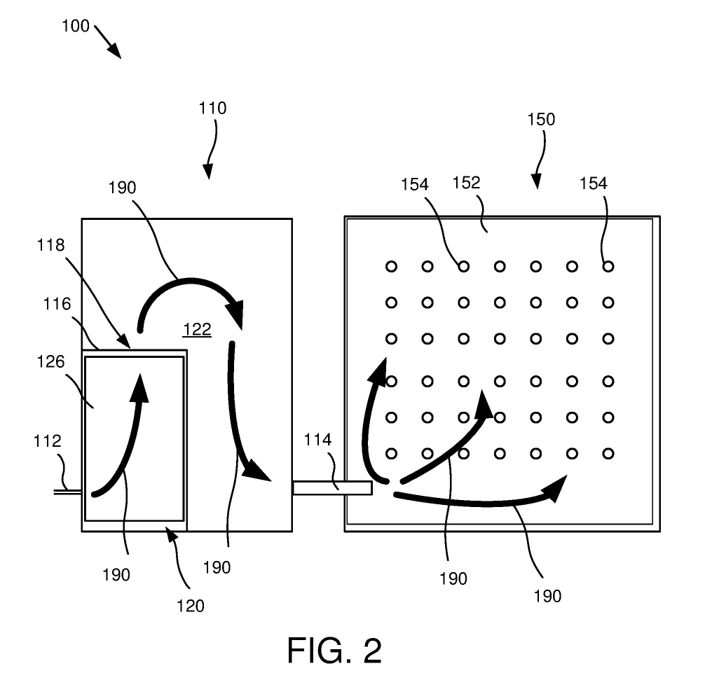

In some embodiments, the separator tank 110 and the filter tank 150 are separate tanks that are fluidly connected but not physically connected. In other embodiments, the separator tank 110 and the filter tank 150 are physically connected or are part of an integrated apparatus 100. In some embodiments, liquid flows from the outlet section 122 through the outlet 114 to the filter tank 150 by gravity. In other embodiments, the outlet 114 includes a pump 115 that pumps liquid to the filter tank 150. In some embodiments, the outlet 114 pumps from a top of the outlet section 122. In other embodiments, the outlet 114 includes a pipe that extends down a certain distance into the outlet section 122. In other embodiments, the outlet 114 includes a pipe that extends near a bottom of the outlet section 122. While the pump 115 is included in FIG. 1, one of skill in the art will recognize that the pump 115 can be included in other embodiments depicted in FIGS. 2-4.

Referring now to the filter tank 150, in some embodiments, the filter tank 150 includes a horizontal baffle 160. Although depicted as horizontal and linear in FIG. 1, the horizontal baffle 160 may include other geometric configurations to separate or divide the interior of the filter tank 150 into sections.

In some embodiments, the horizontal baffle 160 is configured to filter the water or liquid as it flows through the filter tank 150. In some embodiments, the horizontal baffle 160 is configured to divide the filter tank 150 into a first capacity reservoir 170 and a second capacity reservoir 172. The first capacity reservoir 170 is located above the horizontal baffle 160 and the second capacity reservoir 172 is located below the horizontal baffle 160.

In some embodiments, the filter tank 150 includes a distribution tray 152. In some embodiments, the distribution tray 152 is located approximately just below a top of the filter tank 150 with a certain volume above the distribution tray 152 to allow for some liquid that has not yet passed through the distribution tray 152. The distribution tray 152 is configured to distribute the liquid received from the outlet 114 such that the liquid distributes to multiple locations across the horizontal baffle 160. In such embodiments, the liquid will distribute to multiple locations without always feeding the incoming liquid to a single location on the horizontal baffle 160.

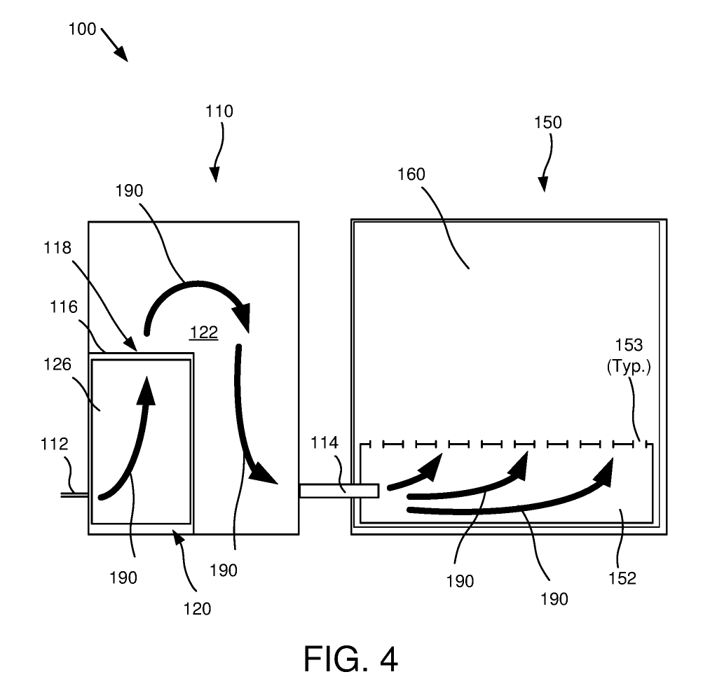

In some embodiments, the distribution tray 152 spans one edge of the filter tank 150 and is configured to distribute liquid along a length of the distribution tray 152 (see, for example, FIG. 4) and distribute liquid over one side of the distribution tray 152 or through openings 153 in one side of the distribution tray 152. The distribution tray 152 may include slots, a flat edge, or a lip over which the liquid spills. In some embodiments, the distribution tray 152 is centered in the filter tank 150 and is configured to distribute liquid along a length of the distribution tray 152 on both sides of the distribution tray 152.

In some embodiments, the outlet 114 is configured to dispense the liquid above the distribution tray 152 of the filter tank 150 and allow the liquid to flow under the force of gravity across the distribution tray 152. In some embodiments, the distribution tray 152 includes a plurality of apertures 154 or other physical components that distribute the liquid to the horizontal baffle 160. In some embodiments, the plurality of apertures 154 are arrayed in a grid on the distribution tray (see, for example, FIG. 2). FIG. 2 depicts a top plan view of the apparatus 100.

In some embodiments, the distribution tray 152 is removably coupled or fixedly coupled to the filter tank 150. In some embodiments, the distribution tray 152 is configured to be adjusted or moved or rotated in a manner to allow for an adjustment of the location of the apertures 154 in relation to the horizontal baffle 160.

The horizontal baffle 160 is located below the distribution tray 152 and allows for the liquid to flow through gravity to the horizontal baffle 160. In some embodiments, the horizontal baffle 160 is spaced vertically from the distribution tray 152 or spaced vertically from a top of the filter tank 150. The vertical spacing allows for a chamber above the horizontal baffle 160 that can store a quantity of the liquid.

Above the horizontal baffle 160 is a first capacity reservoir 170. The first capacity reservoir 170, in some embodiments, is configured to allow for the filling of the first capacity reservoir 170 with a variable quantity of liquid. That is, as the apparatus 100 is utilized, a first volume 174 of liquid may accumulate and store between the distribution tray 152 and the horizontal baffle 160 while the liquid filters through the horizontal baffle 160.

A first capacity reservoir 170 configured as such allows for the filtering of liquid to continue to occur even after the outlet 114 is no longer dispensing liquid into the filter tank 150 as a build-up of liquid is stored within the first capacity reservoir 170. The horizontal baffle 160, in some embodiments, is configured to filter the liquid as it flows down by the force of gravity.

Below the horizontal baffle 160, the filter tank 150 includes a second capacity reservoir 172. The second capacity reservoir 172 is configured to store a second volume 176 of filtered water or filtered liquid. The filtered liquid 176 may then be available for its intended use. The second capacity reservoir 172 may be available as needed and pumped on demand.

The filter tank 150 further includes a filter tank outlet 184. The filter tank outlet 184 is configured to dispense the filtered liquid and, in some embodiments, may be connected to a pump or other device that pumps the filtered liquid as needed. The build-up of the second volume 176 of filtered liquid allows for the intermittent use of the filtered liquid as needed with or without the continual feed of liquid into the inlet 112 of the separator tank 110. The second volume 176 of filtered liquid may be available whether or not there is a first volume 174 of liquid in the first capacity reservoir that is continuing to filter down through the horizontal baffle 160.

In some embodiments, the apparatus 100 is configured to couple to a power washing system for washing vehicles or another system that requires a flow of water greater than the flow of filtered water through the horizontal baffle 160. That is, the apparatus 100, and more specifically the filter tank 150, is configured to store a sufficient quantity of filtered water in the second capacity reservoir 172 to allow for an outflow out the filter tank outlet 184 greater than the inflow through the horizontal baffle 160. With a build-up of filtered water within the second capacity reservoir 172, the apparatus is configured to supply enough filtered water for a specified period of time while water continues to flow through the horizontal baffle 160 at a slower rate.

In some embodiments, the horizontal baffle 160 includes a filter 162. In some embodiments, the filter 162 is distributed across an entirety of the horizontal baffle 160. In other embodiments, the filter 162 is located at gaps in the horizontal baffle 160. In some embodiments, the horizontal baffle 160 may include physical scaffolding that supports the filter 162. In an example, a metal mesh physically supports the filter 162. In another example, a plastic board with slits supports the filter 162. In other embodiments, the filter 163 is supported by horizontal members 163, such as rods, pipes, etc. Many physical configurations are contemplated herein.

In some embodiments, the apparatus 100 is configured to store a sufficient quantity of unfiltered water above the horizontal baffle 160 to accommodate large variations in flow to the horizontal baffle 160 that exceed the capacity of the horizontal baffle 160 to filter. In addition, the first capacity reservoir 170 is configured to store a quantity of unfiltered water as the filtering capacity of the horizontal baffle 160 may vary as the horizontal baffle 160 may become partially plugged.

In some embodiments, the filter tank 150 includes two capacity reservoirs (first capacity reservoir 170 and second capacity reservoir 172) to accommodate large variations in the flow of water into the filter tank 150 and out of the filter tank 150.

In some embodiments, the apparatus 100 is configured to be deployed in a forest or other location where regulations or rules require that seeds be filtered out of water to prevent the spread of unwanted plants and weeds. In an implementation, the apparatus 100 is utilized to power wash vehicles, such as forest service vehicles, and is required to filter out seeds from the water power sprayed onto the vehicles. In such implementations, the apparatus 100 is configured for use with a power washer that has a water demand that is higher than the rate water filters through the horizontal baffle 160 and as such the second capacity reservoir 172 is configured to supply enough water for a specified period of time, e.g. enough time to wash a vehicle. In addition, the first capacity reservoir 170 must have enough capacity to handle the flow for that same period of time.

Referring now to FIG. 2, a top view illustrating an apparatus 100 in accordance with some embodiments of the present invention. As depicted, the apparatus 100 includes the inlet 112 on a side of the separator tank 110. The liquid flows into the inlet section 120 and down towards a bottom of the inlet section 120 towards the opening 118 in the vertical baffle 116 that fluidly connects the inlet section 120 with the outlet section 122. The fluid flow is represented by arrows 190.

Within the inlet section 120, any less dense fluids separate and float to the top of the inlet section 120 and are absorbed by the absorbent pad 126. The fluid exits the inlet section 120 at the opening 118 and enters the outlet section 122. As shown by arrows 190, the fluid flows around and up to the outlet 114. As the fluid flows upwards towards the outlet 114, settling of larger particles will occur.

The fluid flows out the outlet 114 and into the filter tank 150. The fluid flows across the distribution tray 152 as represented by arrows 190 and distributes the fluid to the apertures 154. As depicted, the apertures 154 are distributed across the distribution tray 152 in an arrayed grid. In the illustrated embodiments, the apertures 154 are arrayed in a seven by six grid. However, the apertures 154 may be configured in another type of ordered grid or unordered pattern.

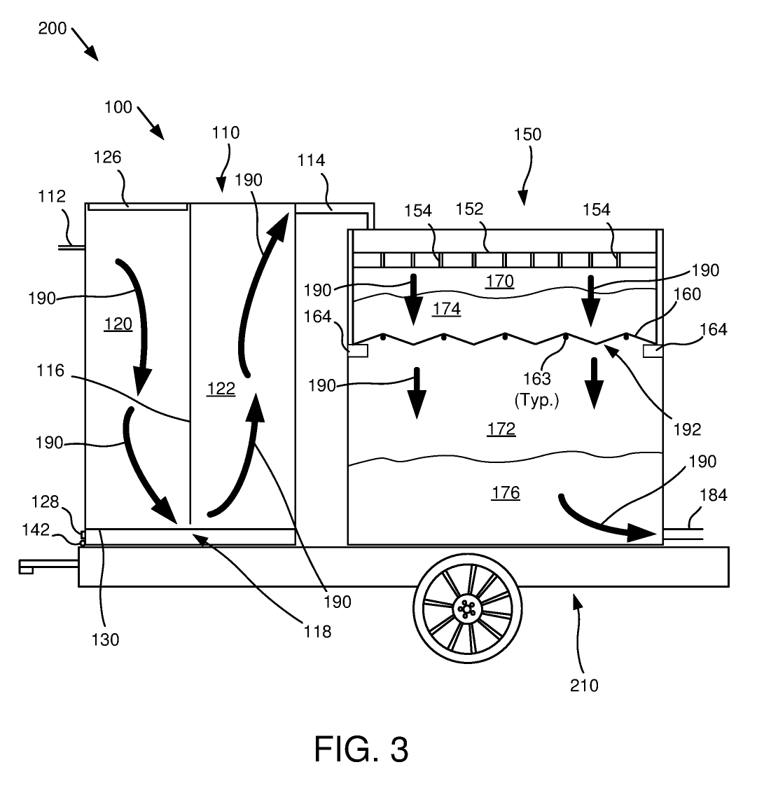

Referring now to FIG. 3, a side view illustrating a system 200 in accordance with some embodiments of the present invention is shown. The system 200 includes an embodiment of the apparatus 100 and further includes a portable trailer 210. The trailer is depicted with two wheels, but could have four or more wheels. The apparatus 100 is coupled to the portable trailer 210. This allows for the apparatus 100 to be mobile and allows for the deployment of the apparatus 100 in remote locations in which the need for a temporary filtering system is present.

In some embodiments, the apparatus 100 is fixedly secured to the portable trailer 210. In other embodiments, the apparatus 100 rests on the portable trailer 210. In some embodiments, the apparatus 100 is removably coupled to the portable trailer 210. In some embodiments, the separator tank 110 and the filter tank 150 are separately couplable to the portable trailer 210.

Referring to the illustrated embodiment, the separator tank 110 is coupled to the portable trailer 210 by a hinged edge 142. The hinged edge 142 is configured to allow the separator tank 110 to be tipped at the hinged edge 142 and allow any remaining liquid to be drained out the drain 128 located at the bottom of the separator tank. The drain 128 may include a hatch that can open to allow access to the bottom of the separator tank 110 to allow for maintenance or service to the interior of the separator tank 110. A hinge similar to hinged edge 142 may be implemented on the filter tank 150 in some embodiments.

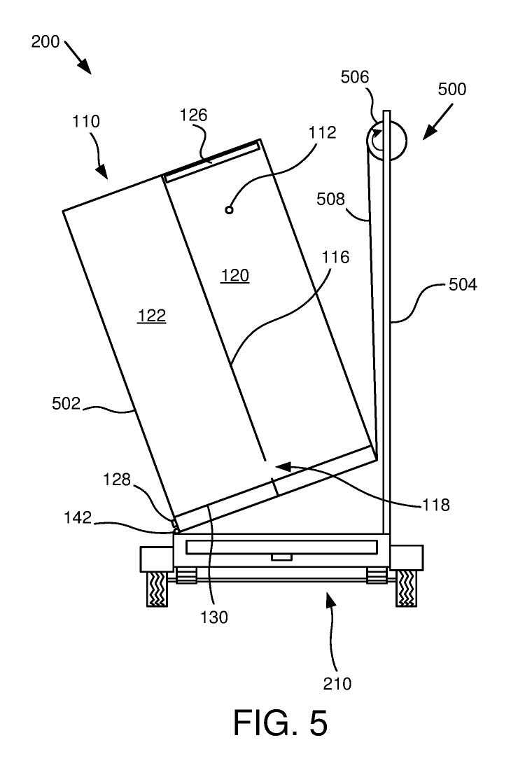

FIG. 5 is a side view illustrating one embodiment of a system 200 in accordance with some embodiments of the present invention with a lifting apparatus 500. In some embodiments, the separator tank 110 includes a removable wall 125 to facilitate removal of dewatered sludge and/or the cleaning of the separator tank 110. In some embodiments, the system 200 includes a lifting apparatus 500 configured to lift or tilt the separator tank 110. Such a lifting apparatus may include a steel frame 504 and a winch 506 with a cable 508 connected to the separator tank 110. In an example, the winch 506 may be attached to the separator tank 110 and when cranked by a power source causes the separator tank 110 to rotate about the hinged edge 142. The lifting apparatus may be coupled to the portable trailer 210, for example, as the frame 504 is coupled in FIG. 5, or may be separate from the portable trailer 210. In other embodiments, the steel frame 504 and winch 506 are positioned on another side of the separator tank 110. In another embodiment, the winch 506 is located at the bottom of the separator tank 110 or somewhere else on the trailer 210 and a pully system lifts a side of the separator tank 110. In another embodiment, a hydraulic lift (not shown) lifts a side of the separator tank 110. One of skill in the art will recognize other configurations for a steel frame 504, winch 506, and/or other components to lift a side of the separator tank 110. In another embodiment, a winch, frame, etc. may be used to lift the filter tank 160.

As depicted by the arrows 190 in FIG. 3, the liquid flows in a similar manner as described in conjunction with FIGS. 1 and 2. Fluid enters at inlet 112 and flows downwards towards opening 118. Within the inlet section 120, less dense liquids separate and float to the top of the inlet section 120 and are absorbed by the absorbent pad 126. For example, the absorbent pad 126 may absorb oil or other liquids less dense than water. The fluid exits the inlet section 120 at the opening 118 and enters the outlet section 122. As shown by arrows 190, the fluid flows up to the outlet 114. As the fluid flows upwards towards the outlet 114, settling of larger particles will occur.

In some embodiments, with the outlet 114 located at a top of the separator tank 110, fluid will not be dispensed out the outlet 114 and into the filter tank until the separator tank 110 is filled to capacity. That is, in such embodiments, the separator tank 110 must fill to the height of the outlet 114 before liquid is dispensed to the filter tank 150.

The liquid flows out the outlet 114 and into the filter tank 150. The fluid flows across the distribution tray 152 and through apertures 154. Under the force of gravity, the liquid flows down to the horizontal baffle 160 (depicted as pleated). After filtering through the horizontal baffle 160, the liquid flows down into the second capacity reservoir 172. The liquid is then dispensed out the filter tank outlet 184.

Referring now to the separator tank 110, the drain 128 is located on a side of the separator tank 110. In addition, the liner 130 spans across the bottom of the separator tank 110 above the drain 128 to separate the drain 128 from the remainder of the interior of the separator tank 110. The vertical baffle 116 extends vertically from the top of the separate tank 110 near to the bottom of the separator tank 110 with a gap between the bottom and the vertical baffle 116. The gap forms an opening that fluidly connects the inlet section 120 and the outlet section 122.

Referring now to the filter tank 150, in one embodiment, the distribution tray 152 and the horizontal baffle 160 are incorporated together as a separate tank 192. The separate tank 192 includes the distribution tray 152 at a top of the separate tank 192 and the horizontal baffle 160 at a bottom of the separate tank 192. The separate tank 192 is housed within the filter tank 150 and rests on ledges 164 which are located around a periphery of the interior of the filter tank 150. The liquid flows into the separate tank 192 at the distribution tray 152 and out the separate tank 192 at the horizontal baffle 160.

In the illustrated embodiment, the separate tank 192 forms the first capacity reservoir 170. The first capacity reservoir 170 is configured to store a first volume 174 of water in the separate tank 192 while the water filters through the horizontal baffle 160.

In the illustrated embodiment, the horizontal baffle 160 is pleated. The horizontal baffle 160 is substantially horizontal and may include geometric configurations, such as pleated, that funnel or direct the liquid to a filter to filter the liquid before entering the second capacity reservoir 172.

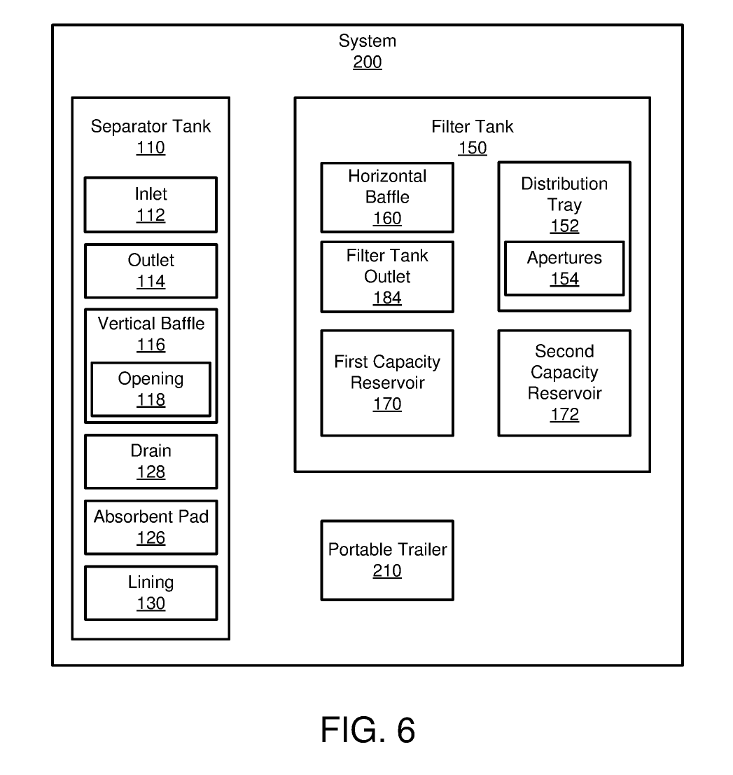

Referring now to FIG. 6, a schematic block diagram illustrating a system 200 in accordance with some embodiments of the present invention is shown. The system 200 includes a separator tank 110, a filter tank 150, and a portable trailer 210. Although the system 200 is shown and described with certain components and functionality, other embodiments of the system 200 may include fewer or more components to implement less or more functionality.

The separator tank 110, in some embodiments, is a container capable of processing liquid from an inlet 112 to an outlet 114. The separator tank 110 may be an enclosable container or an open container. An enclosable container allows for access to the interior a hatch, lid, or the like. An open container allows easy access to the interior. The separator tank 110 may be made of metal, plastic, fiberglass, plywood lined with a non-porous material, or the like. The separator tank 110 is configured to be made of a low weight non-porous material capable of holding a liquid to allow for easy transportability of the separator tank 110.

The separator tank 110 is configured to be sized to fit on a portable trailer. In one embodiment, the separator tank 110 is approximately six feet tall, five feet wide, and seven feet long. Although not explicitly described other sizes are contemplated herein. A separator tank 110 of those dimensions is configured to hold approximately one thousand five hundred gallons.

The separator tank 110 includes an inlet 112. The inlet 112 may be located on a side of the separator tank 110 to allow for an absorbent pad 126 to be disposed at a location above the inlet 112. The inlet 112 is configured to removably couple to a fluid source at a filtering location.

The separator tank 110 further includes a vertical baffle 116. The vertical baffle 116 divides the interior of the separator tank 110 into an inlet section and an outlet section fluidly connected only at an opening 118. In some embodiments, the vertical baffle 116 may be coupled to the side walls of the separator tank 110. In other embodiments, the vertical baffle 116 may be coupled to the side walls and the ceiling of the separator tank 110 with a gap between the floor of the separator tank 110 and the vertical baffle 116. In other embodiments, the vertical baffle 116 may be coupled to the side walls and the floor of the separator tank 110 with an opening 118 near the bottom of the separator tank 110.

The vertical baffle 116 is a physical non-porous divider that separates the interior of the separator tank 110 into the inlet section and the outlet section. The vertical baffle 116 is configured to funnel the liquid down the inlet section and through the opening 118 and back up to the outlet 114. The inlet section is configured to separate oils and other less dense liquids from water by being absorbed by the absorbent pad 126 which may float at a top of the inlet section. The outlet section is configured to separate heavier particles from the water as the heavier particles settle as the liquid flows up towards the outlet 114.

The filter tank 150, in some embodiments, is a container capable of processing liquid though filters of a horizontal baffle 160. The filter tank 150 may be an enclosable container or an open container. The filter tank 150 may be made of metal, plastic, fiberglass, plywood lined with a non-porous material, or the like. The filter tank 150 is configured to be made of a low weight non-porous material capable of holding a liquid to allow for easy transportability of the filter tank 150.

The filter tank 150 is configured to be sized to fit on a portable trailer. In one embodiment, the filter tank 150 is six feet tall, seven feet wide, and eleven feet long. Although not explicitly described other sizes are contemplated herein. A filter tank 150 of those dimensions with a horizontal baffle 160 spaced from the bottom of the filter tank 150 approximately four feet may be configured to hold approximately one thousand two hundred and fifty gallons in the second capacity reservoir 172.

The horizontal baffle 160, in some embodiments, is a structural component that filters liquid through gravity and separates the filter tank 150 into a first capacity reservoir 170 and a second capacity reservoir 172. The horizontal baffle 160 may be fixedly coupled or removably coupled to the side walls of the filter tank 150. The horizontal baffle 160 may rest on a ledge or ledges 164 located around a periphery of the interior of the filter tank 150. The horizontal baffle 160 is configured to be spaced a distance from the top of the filter tank 150 to allow space for accumulation of liquid in the first capacity reservoir 170.

The filter tank 150 may further include a distribution tray 152 configured to distributed the fluid entering the filter tank 150 to distribute across the horizontal baffle 160 at multiple locations. The distribution tray 152 may be a physical apparatus capable of funneling liquid to desired locations. The distribution tray 152 may be fixedly coupled or removably coupled to the side walls of the filter tank 150 or may rest on ledges located around a periphery of the interior of the filter tank 150. Other manners of distributing liquid across the horizontal baffle 160 are envisioned within the scope of this disclosure.

The system 200 further includes a portable trailer 210. The portable trailer 210 can be a flatbed trailer, an enclosed trailer, or specialized trailer that can be pulled behind a vehicle and delivered to a filtering location. Integrating the separator tank 110 and the filter tank 150 into a portable trailer 210 allows for the deployment of embodiments of the invention in remote locations.

Although not depicted, the system 200 may further include various gauges, sensors, and computer systems configured to monitor components, test the filtered liquid, and provide feedback to a user regarding the functioning of the overall system 200.

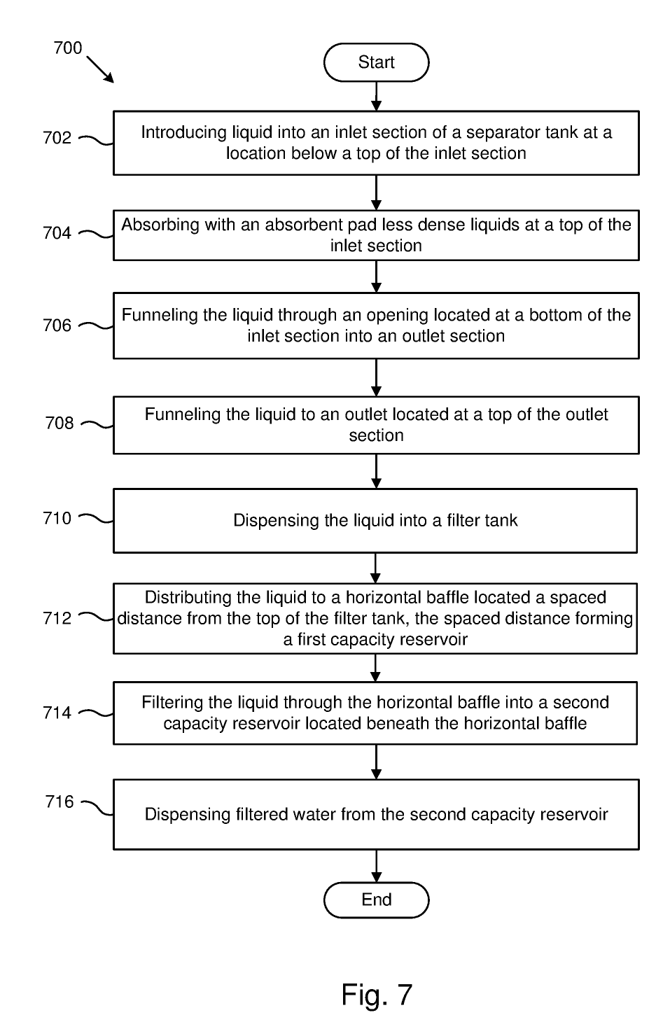

Referring now to FIG. 7, a schematic block diagram illustrating a method in accordance with some embodiments of the present invention is shown. The method 700 introduces 702 liquid into an inlet section of a separator tank at a location below a top of the inlet section. The method 700 absorbs 704 with an absorbent pad less dense liquids at a top of the inlet section.

The method 700 funnels 706 the liquid through an opening located at a bottom of the inlet section into an outlet section. The method 700 funnels 708 the liquid to an outlet located at a top of the outlet section. The method 700 dispenses 710 the liquid into a filter tank and distributes 712 the liquid to a horizontal baffle located a spaced distance from the top of the filter tank, the spaced distance forming a first capacity reservoir. The method 700 filters 714 the liquid through the horizontal baffle into a second capacity reservoir located beneath the horizontal baffle. The method 700 dispenses 716 filtered water from the second capacity reservoir, and the method 700 ends.

In some embodiments, the method may further include variably filling the first capacity reservoir while the liquid is filtered through the horizontal baffle. Although described in a depicted order, the method may proceed in any of a number of ordered combinations and without some of the steps outlined above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagram included herein is generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. An apparatus, comprising:
a separator tank comprising an inlet configured to receive liquid, an outlet, and a vertical baffle dividing the separator tank into an inlet section and an outlet section; and
a filter tank in fluid communication with the outlet, wherein the filter tank comprises a distribution tray approximately at a top of the filter tank, a horizontal baffle below the distribution tray,
wherein the horizontal baffle is spaced vertically from the distribution tray forming a first capacity reservoir and is further spaced vertically above a bottom of the filter tank to form a second capacity reservoir.

2. The apparatus of claim 1, wherein the horizontal baffle comprises a filter configured to filter particles smaller than one hundred microns.

3. The apparatus of claim 1, wherein the first capacity reservoir is configured to store a volume of water between the distribution tray and the horizontal baffle while the water filters through the horizontal baffle.

4. The apparatus of claim 1, wherein the horizontal baffle is pleated.

5. The apparatus of claim 1, wherein the filter tank is separate from the separator tank.

6. The apparatus of claim 1, wherein the separator tank and the filter tank are configured to be coupled to a portable trailer.

7. The apparatus of claim 1, wherein the vertical baffle comprises an opening approximately at a bottom of the vertical baffle, the opening fluidly connecting the inlet section and the outlet section.

8. The apparatus of claim 7, wherein the separator tank further comprises an absorbent pad in the inlet section.

9. The apparatus of claim 8, wherein the absorbent pad floats within the inlet section and is configured to float above the inlet.

10. The apparatus of claim 1, wherein the inlet is positioned below a top of the separator tank.

11. The apparatus of claim 1, wherein the separator tank further comprises:
a drain positioned at a bottom of the separator tank; and
a liner above the drain and spanning the bottom the separator tank.

12. The apparatus of claim 11, wherein the liner comprises a filter configured to filter particles larger than one hundred microns.

13. The apparatus of claim 1, wherein the distribution tray comprises a plurality of apertures arrayed in a grid on the distribution tray and configured to distribute water across the horizontal baffle.

14. The apparatus of claim 1, wherein the filter tank further comprises a filter tank outlet positioned at a bottom of the filter tank configured to release filtered water from the second capacity reservoir.

15. The apparatus of claim 1, wherein the outlet is positioned at a top of the separator tank and is configured to dispense liquid above the distribution tray of filter tank.

16. A system, comprising:
a portable trailer; and
an apparatus coupled to the portable trailer, the apparatus comprising:
a separator tank comprising an inlet configured to receive liquid, an outlet, and a vertical baffle dividing the separator tank into an inlet section and an outlet section; and
a filter tank in fluid communication with the outlet, wherein the filter tank comprises a distribution tray approximately at a top of the filter tank, a substantially horizontal baffle below the distribution tray,
wherein the horizontal baffle is spaced vertically from the distribution tray forming a first capacity reservoir and is further spaced vertically above a bottom of the filter tank to form a second capacity reservoir.

17. The system of claim 16, wherein the first capacity reservoir is configured to store a volume of water between the distribution tray and the horizontal baffle while the water filters through the horizontal baffle.

18. The system of claim 16, wherein the separator tank is coupled to the portable trailer by a hinged edge configured to tip the separator tank at the hinged edge.

19. The system of claim 16, wherein the separator tank further comprises:
a drain positioned at a bottom of the separator tank; and
a liner above the drain and spanning the bottom the separator tank, wherein the liner comprises a filter configured to filter particles larger than one hundred microns.

20. A multi-stage filter apparatus, comprising:
a separator tank comprising an inlet configured to receive liquid, an outlet, and a vertical baffle dividing the separator tank into an inlet section and an outlet section,
wherein the vertical baffle comprises an opening approximately at a bottom of the vertical baffle, the opening fluidly connecting the inlet section and the outlet section, wherein the separator tank further comprises an absorbent pad in the inlet section, wherein the absorbent pad floats within the inlet section,
wherein the separator tank further comprises a drain positioned at a bottom of the separator tank and a liner above the drain and spanning the bottom the separator tank, wherein the liner comprises a wire mesh; and
a filter tank in fluid communication with the outlet, wherein the filter tank comprises a distribution tray approximately at a top of the filter tank, a substantially horizontal baffle below the distribution tray,
wherein the horizontal baffle is spaced vertically from the distribution tray forming a first capacity reservoir and is further spaced vertically above a bottom of the filter tank to form a second capacity reservoir, and wherein the horizontal baffle comprises a filter configured to filter particles smaller than one hundred micron.
